(19) United States
(12) Patent Application Publication
(10) Pub. No.: US 2014/0326668 A1
(43) Pub. Date: Nov. 6, 2014

(54) USING GEOPRESSURE TO DESALINATE WATER

(71) Applicant: InnerGeo, Corpus Christi, TX (US)

(72) Inventor: Ronald Lee Loveday, Corpus Christi (TX)

(73) Assignee: INNERGEO, Corpus Christi, TX (US)

(21) Appl. No.: 14/271,240

(22) Filed: May 6, 2014

Related U.S. Application Data
(60) Provisional application No. 61/855,046, filed on May 6, 2013.

(51) Int. Cl. C02F 1/44; B01D 61/02

(52) U.S. Cl. CPC C02F 1/441; B01D 61/025; C02F 2101/32
USPC 210/651; 210/170.01; 210/652; 210/407; 210/123

(57) ABSTRACT

An apparatus and method for desalinating fluids produced or returning from a subterranean formation using pressure from a subterranean formation. Fluid from a formation is sent to a liquid/liquid separator for separating water from the fluid and then to a reverse osmosis unit, one or more of which are configured to operate from pressure delivered from a subterranean formation. The liquid/liquid separator operates under pressure and includes oleophilic materials for extracting oil from the formation fluid.

### CROSS-REFERENCE TO RELATED APPLICATIONS

This Application claims the benefit of U.S. Provisional Application 61/855,046 filed on May 6, 2013, the disclosure of which is incorporated by reference herein in its entirety.

This invention relates to a system for converting produced or frac flowback water from hydrocarbon and other wells into separate streams of fresh water and salty water using the geopressure or manmade pressure of the well.

### BACKGROUND OF THE INVENTION

Many oil and gas wells produce some quantity of water either over relatively short periods such as recovering water used in hydraulic fracking operations or over long periods of time in the natural course of production. There are many areas of the world where such produced water can be desalinated to provide a stream of fresh or less salty water and a stream of brine or more salty water.

The major approaches for desalinating water are multistage distillation and reverse osmosis. Both approaches have their advantages and disadvantages so the most opportune technique depends on a variety of factors at each particular location where the installation is to be built.

Disclosures of some relevance to this invention are found in U.S. Pat. Nos. 3,651,617; 4,652,372; 4,983,305; 5,076,934; 5,080,781; 5,200,083; 5,695,643; 6,193,893; 6,875,364; RE 36,282; 7,241,382; 7,410,577; 7,468,082; 7,600,567 7,845,406; 7,866,385 and 8,097,128 and U.S. Printed Patent Application 2011/0005749.

### BRIEF SUMMARY OF THE INVENTION

The broad concept of this invention is to use the natural or manmade pressure of a subterranean formation as the power source to desalinate produced or frac water. The stream from a well is directed to a separator where gas and liquids are separated. In situations where hydrocarbon liquids and water are produced, the hydrocarbon liquids are separated from water.

The produced water can be processed to remove any residual liquid hydrocarbons and any suspended particulates while retaining a considerable fraction of the pressure of produced fluids. The produced water under pressure, or with a minimum of pressure supplied by an external source, is delivered to a reverse osmosis unit which divides the incoming water stream into a stream of relatively fresh water and a stream of relatively salty water. The proportion of fresh water to salty water depends on the pressure available and the composition of the incoming water.

It is an object of this invention to provide a system for desalinating water produced from wells by using the natural or manmade pressure of the produced fluids.

Another object of this invention is to use the energy of fluids produced from hydrocarbon wells to provide a stream of relatively fresh water. In addition, a well can be drilled into a subterranean formation that is under natural geopressure not for the purpose of hydrocarbon recovery, but for producing brine water to make it fresh. Water wells of this nature will likely contain varying quantities of hydrocarbons and other compounds that need to be stripped out to produce water. It is an object of this invention to use the pressure of the subterranean formation to assist in this endeavor.

According to one embodiment of this invention, a liquid/liquid separator is provided that is operated at least in part by pressure from a subterranean formation. The liquid/liquid separator is pressurized an contains an oleophilic material in the form of a belt, a rope, a screen, or the like, and desorbs oil from the oleophilic material near a valve where the oil exits the separator under pressure.

According to one embodiment, there is presented an apparatus for desalinating water from a well comprising a liquid/liquid separator configured to receive from a subterranean formation a fluid having at least a first and a second liquid, wherein the liquid/liquid separator is further configured to separate, under pressure, the first liquid from the second liquid, and wherein the first liquid exits the liquid/liquid separator through a first outlet, and the second liquid exits the liquid/liquid separator through a second outlet and a reverse osmosis unit configured to receive the second liquid from the second outlet and further configured to operate at least in part by pressure supplied from the subterranean formation. In one embodiment, the first liquid comprises oil and the second liquid comprises water.

In another embodiment, the liquid/liquid separator is configured to operate under pressure from the subterranean formation, in whole or in part. In one embodiment, the liquid/liquid separator comprises at least one oleophilic screen. In one embodiment, the liquid/liquid separator further comprises a squeegee, a pinch or compression roller, or a wiper, and at least one of the oleophilic screens is configured to rotate. In another embodiment, the pressure supplied from the subterranean formation causes the at least one oleophilic screen to rotate. In another embodiment, the liquid/liquid separator comprises at least one oleophilic belt. In another, the separator comprises at least one oleophilic rope. The separator can also further comprise a plurality of rope guides connected to at least one screen.

In one embodiment, the apparatus for desalinating water from a well further comprises a turbine that operates by pressure from the subterranean formation. In another, the apparatus comprises a positive displacement rotary drive that operates by pressure from the subterranean formation. The positive displacement rotary drive converts kinetic energy into mechanical energy and is operable to convert pressure to, for example, a rotational force to rotate the oleophilic screens, or power the drive motor to drive the oleophilic belts.

There is presented, according to one embodiment, a method for reducing the salinity of fluid produced from a subterranean formation comprising supplying fluid produced from a subterranean formation to a liquid/liquid separator, separating water in the fluid from other liquids in the fluid, passing the water to a reverse osmosis unit, reducing the salinity of the water, wherein the reverse osmosis unit is operated by pressure supplied by the subterranean formation. In one embodiment, the method further comprises separating oil in the fluid from other liquids in the fluid. In another, the oil is separated by an oleophilic material selected from the group consisting of a belt, a screen, and a rope. In one embodiment, the subterranean formation is pressurized, such as from fracking operations.

According to another embodiment, there is presented a liquid/liquid separator for separating oil from other liquids comprising a pressurized tank for receiving from a subterranean formation a fluid having oil and at least a second liquid, at least one oleophilic material positioned within the tank, a motor for moving the at least one oleophilic material within the pressurized tank, a device for desorbing oil from the at least one oleophilic material, and at least one valve positioned near the device to allow the oil to exit the tank.

In one embodiment, the oleophilic material can be in the form of a belt, or a screen, or a rope, or a combination of the three. According to one embodiment, oil can be extracted from the oleophilic material by a squeegee, a pinch or compression roller, a wiper, or a twist guide. Valves located in the liquid/liquid separator, according to one embodiment, comprise a floater that floats in water and sinks in oil.

These and other objects and advantages will become more fully apparent as this description proceeds, reference being made to the accompanying drawings.

### BRIEF DESCRIPTION OF THE DRAWINGS

FIG. 1 is a is a schematic drawing of a conventional surface installation where the produced fluids are predominately natural gas and water;

FIG. 2 is a is a schematic drawing of a surface installation where the produced fluids are predominately natural gas and water and the pressure of the produced fluids is used to produce a stream of relatively fresh water;

FIG. 3 is a schematic drawing of a surface installation where the produced fluids are oil, gas and water and the pressure of the produced fluids is used to produce a stream of relatively fresh water;

FIG. 4 and is an enlarged cross-sectional view of an absorbent endless belt type secondary oil separator;

FIG. 5 shows an embodiment of an oil separator according to aspects of the present disclosure;

FIGS. 6A-B show another embodiment of an oil separator according to aspects of the present disclosure;

FIG. 7A-C show another embodiment of an oil separator according to aspects of the present disclosure.

### DETAILED DESCRIPTION OF THE INVENTION

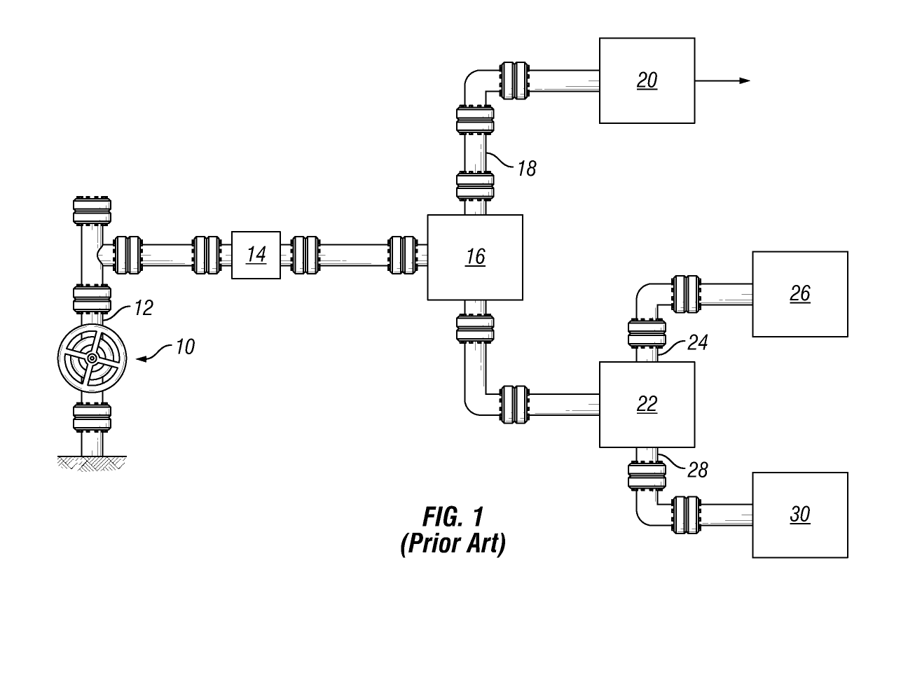

Referring to FIG. 1, a gas well 10 produces through a Christmas tree 12 which may or may not have a choke 14 reducing the flowing pressure to a workable value. Downstream of the choke 14, the full well stream passes through a separator 16 with the gas passing through a flow line 18 to a dehydrator 20 or other downstream treating equipment and then to a sales meter. Although the separator 16 may be a three phase separator which is a gas/liquid/liquid separator, it is illustrated as a two phase or gas/liquid separator. Liquids from the separator 16 pass to a liquid/liquid separator 22 where natural gas liquids, i.e. butane, propane, hexane are taken off through one outlet 24 to a tank 26 and water out of a second outlet 28 to a tank 30. Notations on FIG. 1 show the change in pressure from the relatively high flowing pressure at the tree 12 to atmospheric pressure in the tanks 26, 30. A liquid/liquid separator 22 separating natural gas liquids from water may be operated at a moderate pressure in the range of 15-125 psig. In one embodiment, the liquid/liquid separator operates above 80 psig. Separators separating other liquids operate at other pressures, such as above 125 psig. Depending on the liquids to be separated, a liquid/liquid separator as contemplated herein may operate at higher pressures, such as 1000 psig, 2000 psig, 3500 psig, or higher. The amount of required pressure varies depending on the composition of the incoming liquids and the desired level of separation of the liquids. As used herein, a liquid/liquid separator may be a separate unit or may be part of a three phase separator.

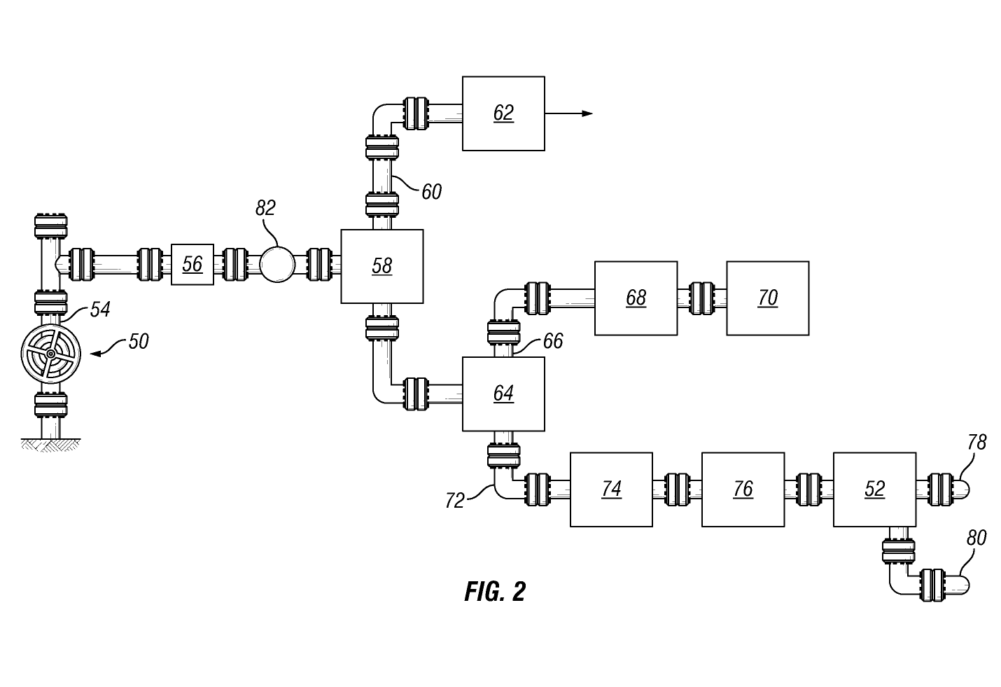

Referring to FIG. 2, the broad concept disclosed herein is to use the pressure of produced fluids from a well 50 to operate a reverse osmosis unit 52 to deliver a stream of water of reduced salinity. The well 50 may be a gas well immediately after a large frac job where the water being produced is largely water used in the frac job or the gas well may produce water on a long term basis. In the alternative, the well may be a well drilled for the purpose of producing water.

The exact amount of pressure needed by the reverse osmosis unit 52 also varies substantially depending on the composition of incoming water and the desired proportion between fresh water and brine in the output stream. A typical installation may require about 500 psig to operate, which can be entirely supplied by the pressure of the formation if the well 50 and its surface equipment is operated appropriately. For example, a reverse osmosis membrane separator tasked with separating fresh water from sodium chloride (salts) at 1200 parts per million (ppg) may only require 80 psig, whereas the separation of some formation fluids at 30,000 ppm would require higher pressure, such as 1200 psig. In one embodiment, the reverse osmosis unit operates at a pressure above 80 psig. In another, it operates above 200 psig. In yet another embodiment, it operates above 500 psig. In many cases, the entirety of the pressure can be supplied by pressure from the subterranean formation and thus no additional energy would be required to operate the surface equipment. FIG. 2 shows the well 50 producing through a Christmas tree 54 which may or may not have a choke 56 reducing the flowing pressure to a workable value. Downstream of the choke 56, the well stream can pass through a gas/liquid separator 58 which may be a three phase separator but which is illustrated as a two phase separator with water saturated gas passing through a flow line 60 to a dehydrator 62 or other downstream treating equipment and then to a sales meter. Liquids from the separator 58 can pass to a liquid/liquid separator 64 operating at a high enough pressure to operate the reverse osmosis unit 52, i.e. at a significantly higher pressure than the conventional liquid/liquid separator 22. Natural gas liquids are taken off through one outlet 66 possibly to a subsequent treating vessel 68 where pressure is reduced to atmospheric and then delivered to a tank 70 where the liquids are transported by truck or pipeline to sales. Water is taken off through a second outlet 72 to a sand filter 74, other filters 76 such as an activated charcoal filter, and finally the reverse osmosis unit 52 which produces a stream of fresh water through an outlet 78 and a brine stream through an outlet 80. The brine can then be trucked off or injected in a well but its volume is considerably reduced. The fresh water from the outlet 78 is highly prized in many oil/gas fields of the world. As used herein, fresh water is intended to mean water of reduced salinity compared to incoming water, and brine is intended to mean water of increased salinity compared to incoming water.

In order to generate some electricity, a turbine 82 may be placed in a high pressure area of the surface equipment, such as upstream or immediately downstream of the choke 56. In another embodiment, a positive displacement rotary drive is used. The positive displacement rotary drive can be placed downstream of choke 56, but is more efficient in the lower pressure region downstream of separator 58. In one embodiment, the positive displacement rotary drive is located within liquid/liquid separator 64 and is operable to drive components of the liquid/liquid separator 64, such as oleophilic components. Other energy conversion devices known in the art are contemplated, such as those that convert pressure to mechanical or electrical energy.

It will be seen that a major expense of a reverse osmosis unit has been eliminated by operation of the unit 52 using the pressure of the produced fluids as the motive power to force water molecules through the membrane of the reverse osmosis unit 52.

The same basic approach can also be used on flowing oil wells if they have enough flowing pressure. The oil wells may be flowing back frac water, proppant and fracing chemicals following a large frac job or may produce water on a long term basis. As disclosed herein, pressure of fluid produced from a well can be in the form of natural formation pressure or can be in the form of manmade well pressurization as a result of fracking, or expanding fluids under temperature gradients, or any other form of manmade pressurization of a formation. Along the same vein, fluid produced from a well can be natural formation fluid or can also be fluid injected into the formation, for example for fracking purposes.

There is a problem with oil wells because conventional liquid separators aren't perfect, i.e. the water coming from conventional liquid/liquid separators includes probably 1% oil and another 1% particulates, meaning untreated produced water will foul reverse osmosis membranes relatively quickly. One technique to treat water before entering a filter array is to use a centrifuge or cyclone between the final liquid/liquid separator and the filter array.

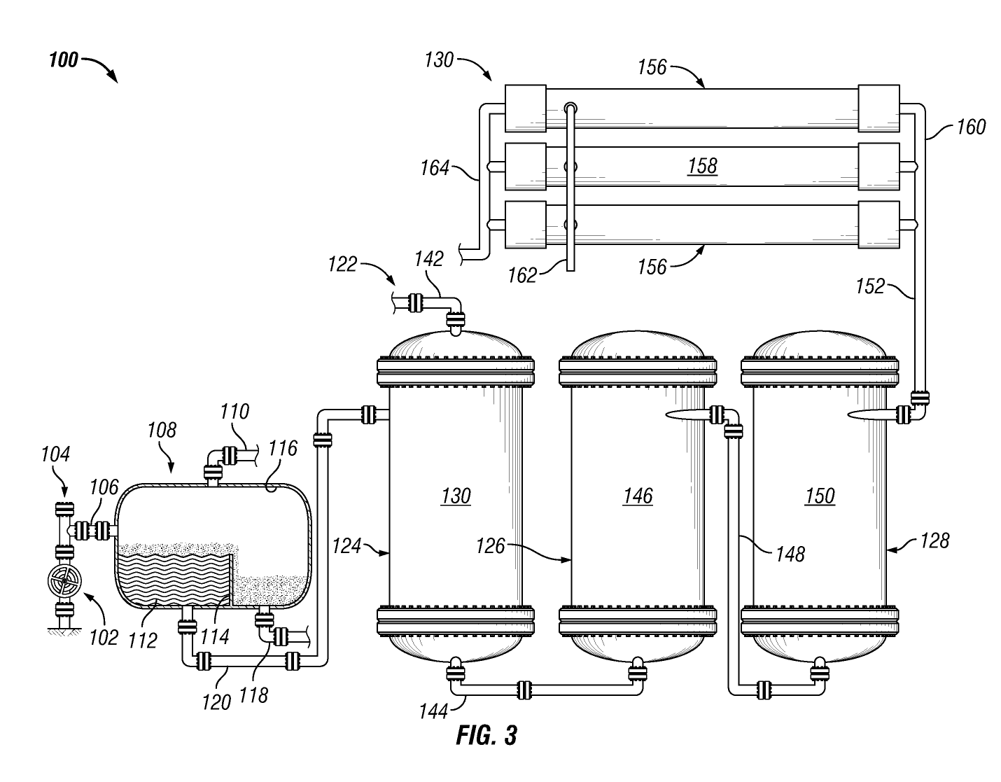

Another approach is shown in FIG. 3 where a surface installation 100 for an oil well 102 includes a Christmas tree 104 which may or may not have a choke 106 for regulating the amount of fluid produced. Downstream of the choke 106 is a separator 108 which is illustrated as a three phase or gas/liquid/liquid separator having a gas outlet 110 leading to a sales line or flare depending on the economics of recovering the produced gas. Liquid in the separator 108 collects in a primary compartment 112 where liquid hydrocarbons overflow a weir 114 into a secondary compartment 116. An outlet 118 from the secondary compartment 116 allows oil to pass toward a gun barrel, tankage or other facility (not shown) where oil is ultimately delivered to a buyer.

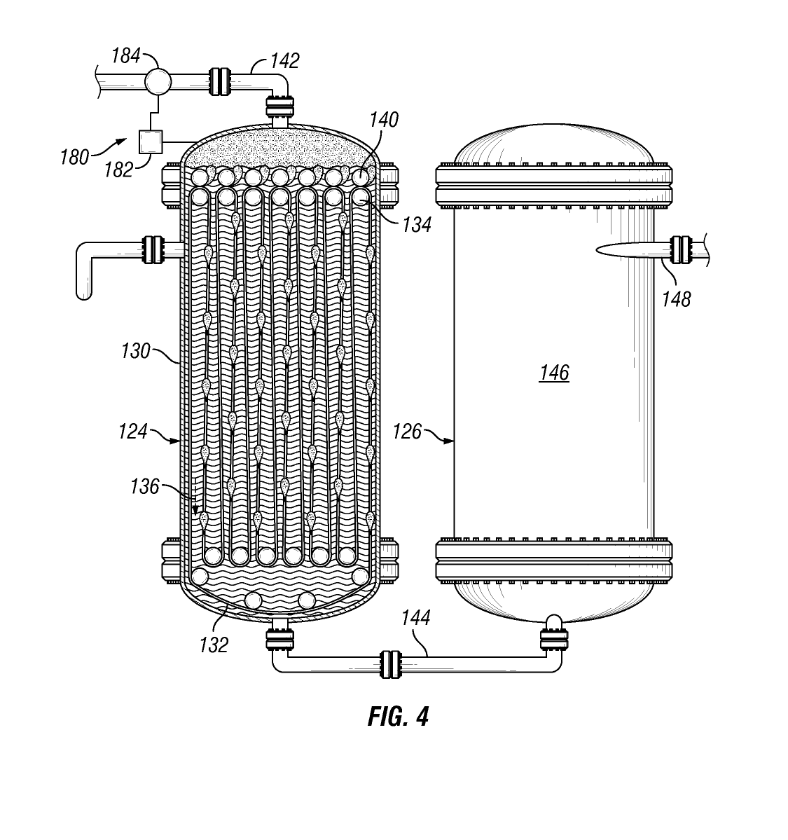

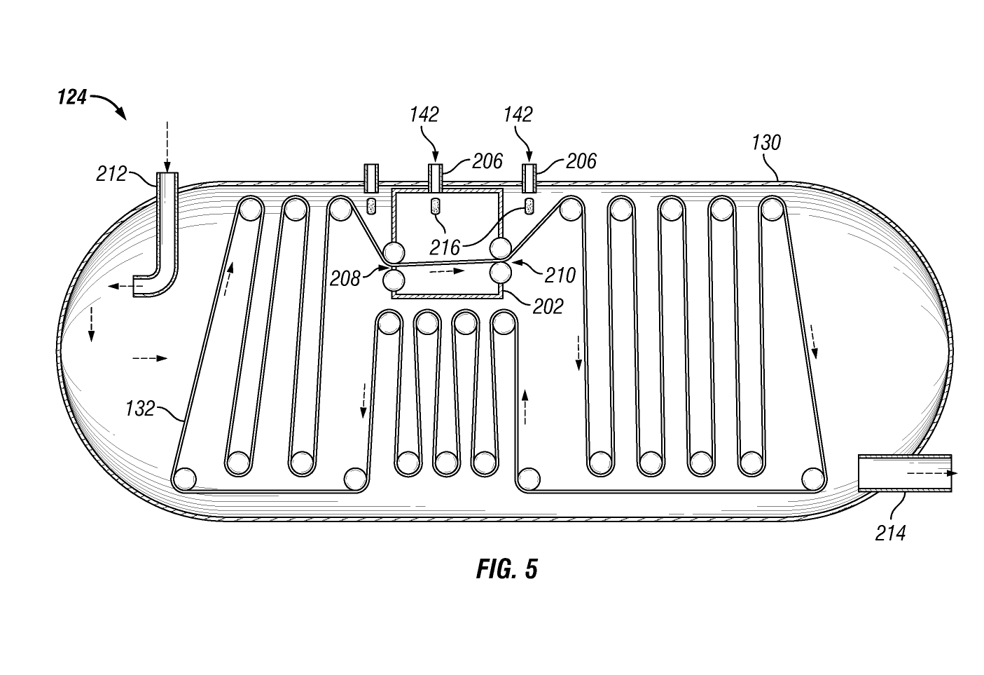

A second outlet 120 delivers water from the separator 108 to a water treatment system 122 which can include a secondary oil separator 124, a sand filter 126, another filter 128 which may be an activated charcoal filter and an array 130 of reverse osmosis units. The secondary oil separator 124 is of a type that removes trace amounts of oil from copious amounts of water and may be of the absorbent endless belt type shown in FIG. 4, or other designs such as those shown in FIGS. 5-7.

Referring to FIG. 4, the secondary oil filter 124 may include a vessel 130 having therein an endless belt 132 of oleophilic material, which is preferably hydrophobic, one example of which is woven or unwoven polypropylene of substantial surface area. The belt 132 accordingly has the property of preferentially collecting or coalescing oil as opposed to water. The belt 132 is driven around a series of pulleys 134 as suggested by the arrow 136 to present a large surface area on which oil droplets 138 may coalesce. As the belt 132 rises toward the top of the vessel 130, it passes between pinch rollers 140 and pulleys 134 to expel any oil adhering to the belt 132 so it may accumulate in the top of the vessel 130 and exit through an outlet 142 to a gun barrel, tankage or other installation for ultimate delivery to sales. The pinch rollers 140 may be oleophobic to minimize transfer of oil back to the belt 132. Because secondary oil separator 124 operates in a hydro environment, oil pulled out of the liquid by way of the pinch rollers tends to float, resulting in an oil-water separation level within tank 130. In addition, because vessel 130 is pressurized, according to the present example, the oil-water separation level can be actively manipulated.

The oil-water level in the top of the vessel 130 can be preferentially arranged to be above the pinch rollers 140 to minimize transfer of oil back to the belt 132. To this end, an oil-water interface detection system 180 may be provided having one or more sensors (not shown) exposed inside the top of the vessel 130 connected to a controller 182 which in turn controls the position of a valve 184 in the oil outlet conduit 142. The system 180 detects when the oil level approaches the pinch rollers 140 and opens the valve 184 to allow oil in the vessel 130 to flow to suitable tankage or other downstream treating equipment.

FIG. 5 depicts another embodiment according to the present disclosure. Secondary oil separator 124 contains endless belt 132, oil separation container 202, and oil extraction valves 206. Liquid enters pressurized tank 130 through inlet port 212. Endless belt 132 enters oil separation container 202 through non-pinch rollers 208. Pinch rollers 210 facilitate removal of the oil from oleophilic material contained in endless belt 132. As contemplated in this embodiment, more than one set of pinch rollers may be present within oil separation container 202. Separated oil flows through oil extraction valves 206, propelled by pressure of vessel 130. The oil-water level within oil separation container can be arranged according to the interface detection system 180 disclosed above (not shown in FIG. 5). Valves 206 operate to remove additional oil from vessel 130. Water exits through port 214.

Valves 206, according to one embodiment, are placed near the top of tank 130. As oil is desorbed from oleophilic belt 132, it floats above the separated water. Because pinch rollers 210 are placed at the exit of oil separation container 202, most of the oil is desorbed into oil separation container 202 and extracted through the valve 206 located within container 202. Valves 206 open to allow the oil to be siphoned off and further processed or sent to a sales meter. Valves 206 may be one of a number of designs known in the art. In addition, valves may employ a closed-loop oil leveler as described above. In one embodiment, valves 206 contain floater 216. Floater 216 consists of a material that floats in water, but sinks in oil. As oil floats to the top of tank 130, floater 216 sinks, opening valve 206 and allowing oil to escape through outlet 142. As oil escapes, the water level rises pushing floater 216 back up to close valve 206. According to another embodiment, oil separation container 202 can be located elsewhere in tank 130.

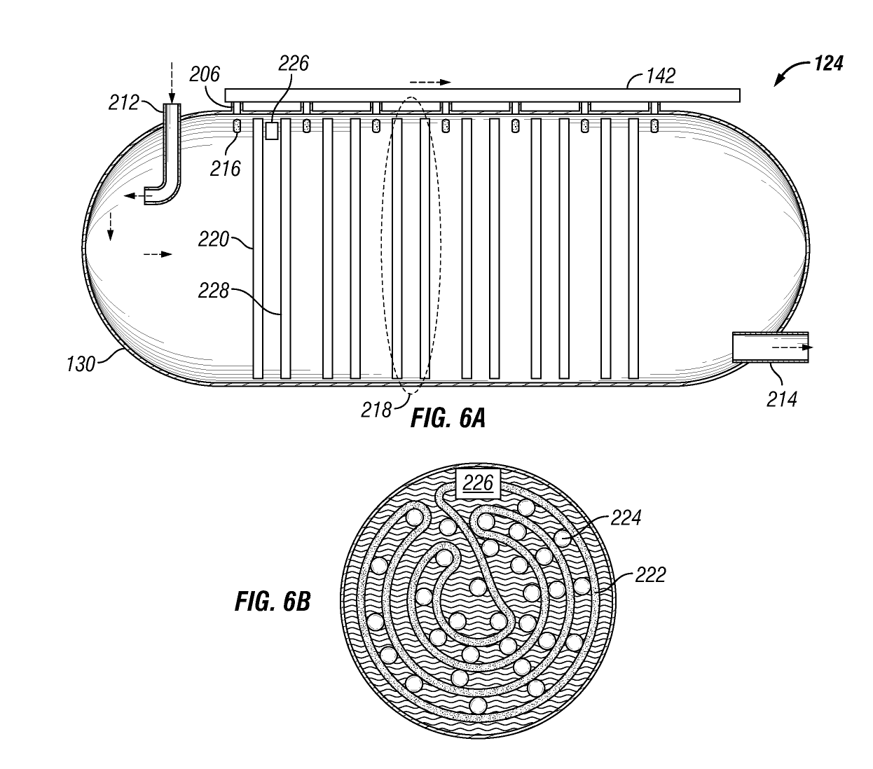

FIGS. 6A and 6B show another embodiment according to the present disclosure. In this embodiment, tank 130 contains at least one oil separation bank 218. Oleophilic rope 222 threads rope guides 224. Drive unit 226 provides motive force to pull oleophilic rope 222 through and around rope guides 224 where oleophilic rope 222 attracts and retains oil. Drive unit, as contemplated according to one embodiment, also contains an oil extraction apparatus, such as a pinch roller, for removing oil from oleophilic rope 226. In another embodiment, pinch rollers can be placed elsewhere along the path of oleophilic rope 226. Other oil extraction apparatus designs may be used, such as squeegees, wipers, or rope twist guides. Rope twist guides cause line twist in the oleophilic rope to desorb oil.

Oil separation bank 218, as represented in FIG. 6A, includes a second screen 228 for use as a backplate. Fluid from a well flows through front screen 220 to oleophilic rope 222 and then through backplate screen 228. Rope guides 224 can be attached to front screen 220 or backplate screen 228, or both. According to one embodiment, front screen 220 and backplate screen 228 differ in design. For example, backplate screen 228 can have smaller diameter holes to increase the pressure within the interior of oil separation bank 218. Screens such as wire mesh, drilled holes, or other forms of screen design known in the art are herein contemplated. Within tank 130, multiple oil separation banks 218 are contemplated. The banks 218 can be identical in design or they can differ according to position within tank 130. For example, oleophilic rope 222 can become larger in gauge as the fluid progresses through tank 130. In addition, bank 218 may employ both a front screen 220 and a backplate screen 228, or it may only employ a backplate screen 220, relying on fluid pressure to keep oleophilic rope 222 on the guides 224. In the alternative, backplate screen 228 may not be used, instead relying on guide 224 guards (not shown) to keep oleophilic rope 222 from falling off guides 224.

Valves 206, according to one embodiment, are placed near drive units 226. As oil is squeegeed from oleophilic rope 222, it floats above the separated water and exits tank 130 through valves 206, as described earlier in the present application.

According to the described embodiment, bank 218 contains oleophilic rope 222. Other types of oleophilic materials can also be used. For example, bank 218 can use an oleophilic belt or other types of materials that can be thread through guides by a drive unit.

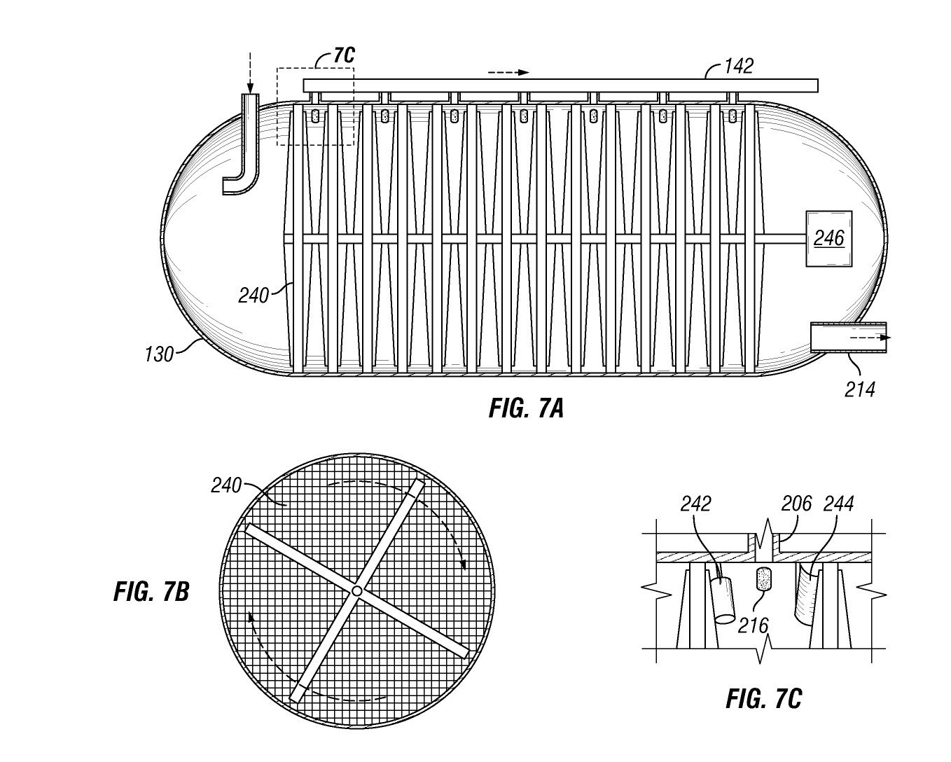

FIGS. 7A-C illustrate another embodiment according to the present disclosure. Within tank 130 is at least one oleophilic screen 240, which contains oleophilic material as described elsewhere in this document. Oleophilic screen 240 can comprise a wire mesh, drilled holes, or other forms of screen design known in the art. According to one embodiment of the present disclosure, one or more oleophilic screens 240 are attached to drive motor 246. As fluid travels through tank 130, oil droplets within the fluid becomes attached to the oleophilic material on oleophilic screens 240. Under rotational force from drive motor 246, oleophilic screens 240 rotate. A portion of oleophilic screens 240 are contacted by compression rollers 242 or squeegees 244. Compression rollers or squeegees 244 extract oil from the oleophilic material and deposit the oil at the top of tank 130, where it can be siphoned off through valves 206 into outlet port 142.

According to one embodiment, tank 130 contains multiple oleophilic screens 240. In one embodiment, all oleophilic screens 240 rotate. Rotational force can be imparted on oleophilic screens 240 by motor 246. In one embodiment, rotational force is imparted on the screens by pressure from the subterranean formation. Geometry of the screens causes the screens to rotate as fluid travels through tank 130. In another embodiment, some or all oleophilic screens 240 are fixed. In the fixed design, oleophilic screens 240 collect tiny oil droplets from well fluid. These droplets grow in size and may then be forced off of the oleophilic material of one oleophilic screen 240 by fluid pressure within tank 130. According to one embodiment, each bank of oleophilic screens 240 is tailored for different droplet sizes. This can be accomplished by varying geometry, mesh size or hole size in the screens, or by varying consistency of oleophilic materials on the oleophilic screens 240. Oil droplets grow in size as they travel from screen to screen. When the droplets reach the preferred size, they can enter banks of rotating oleophilic screens 240 where the oil is squeegeed off as described above. Or, in the alternative, the oil can be funneled toward the top of tank 130 by the geometry of oleophilic screens 240, or by non-oleophilic funneling screens designed for that purpose. In yet another embodiment, wipers may be positioned to direct the oil toward valves 206. The wipers themselves can be centrally mounted on the oleophilic screens 240 and rotate around the screen, or the wipers may traverse the screen in an perpendicular direction.

The design disclosed in FIGS. 7A-C contains no belts and thus provides for less maintenance. In addition, it contains fewer moving parts and allows for more oleophilic surface area to be presented to well fluid traveling through tank 130.

As contemplated herein, tank 130 can contain both banks of oleophilic screens 240 and banks of oleophilic rope 222. According to one embodiment, drive motor 246 is housed outside of tank 130. Valves 206 can be placed in between each oleophilic screen 240, or at intervals as preferred.

Water from the vessel 130 passes through an outlet conduit 144 to the next filter 126 which may be filled with sand and or microfiber filter to separate many of the particulates from the water. The sand filter and or microfiber filter 126 includes a vessel 146 receiving water through the conduit 144 and an outlet conduit 148 delivering water to the next filter 128 which may be filled with activated charcoal. The filter 128 includes a vessel 150 receiving water through the conduit 148 and having an outlet conduit 152 delivering water to the reverse osmosis unit array 130 which may include a series of reverse osmosis units 156.

The reverse osmosis units 156 may be of a conventional type including a vessel 158, an inlet manifold 160, a brine outlet manifold 162, a fresh water outlet manifold 164 and an internal membrane (not shown) designed to pass water molecules to the fresh water outlet manifold 164 and divert larger molecules toward the brine outlet manifold 162. It will be seen that the separator 108, secondary oil filter 124, sand filter and or microfiber filter 126 and activated charcoal filter 128 are operated at a pressure sufficient to force water molecules through the membranes in the reverse osmosis units 156. In this manner, the reverse osmosis unit array 130 is operated by pressure of the produced fluids from the well 102. In the alternative, a supplementary pump may be provided in any of the conduits to the installation to supplement the pressure of the produced fluids when they become insufficient to operate the reverse osmosis units 156 at a desired output.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention.

What is claimed is:

1. An apparatus for desalinating water from a well comprising:
a liquid/liquid separator configured to receive from a subterranean formation a fluid having at least a first and a second liquid,
wherein the liquid/liquid separator is further configured to separate, under pressure, the first liquid from the second liquid, and
wherein the first liquid exits the liquid/liquid separator through a first outlet, and the second liquid exits the liquid/liquid separator through a second outlet;
a reverse osmosis unit configured to receive the second liquid from the second outlet and further configured to operate by pressure supplied from the subterranean formation.

2. The apparatus of claim 1, wherein the first liquid comprises oil and the second liquid comprises water.

3. The apparatus of claim 1, wherein the liquid/liquid separator is configured to operate under pressure from the subterranean formation.

4. The apparatus of claim 1, wherein the liquid/liquid separator comprises at least one oleophilic screen.

5. The apparatus of claim 4, further comprising a device selected from the group consisting of a squeegee, a compression roller, and a wiper, and
wherein the at least one oleophilic screen is configured to rotate.

6. The apparatus of claim 5, wherein the at least one oleophilic screen is configured to rotate from pressure supplied from the subterranean formation.

7. The apparatus of claim 1, wherein the liquid/liquid separator comprises at least one oleophilic belt.

8. The apparatus of claim 1, wherein the liquid/liquid separator comprises at least one oleophilic rope.

9. The apparatus of claim 8, wherein the liquid/liquid separator further comprises a plurality of rope guides connected to at least one screen.

10. The apparatus of claim 1 further comprising an energy conversion device that operates by pressure from the subterranean formation selected from the group consisting of a turbine and a positive displacement rotary drive.

11. The apparatus of claim 1, wherein pressure is further delivered by a supplemental pump.

12. A method for reducing the salinity of fluid produced from a subterranean formation comprising:
supplying fluid produced from a subterranean formation to a liquid/liquid separator;
separating water in the fluid from other liquids in the fluid;
passing the water to a reverse osmosis unit;
reducing the salinity of the water, wherein the reverse osmosis unit is operated by pressure supplied by the subterranean formation.

13. The method of claim 12 further comprising:
separating oil in the fluid from other liquids in the fluid.

14. The method of claim 13, wherein the oil is separated by an oleophilic material selected from the group consisting of a belt, a screen, and a rope.

15. The method of claim 12 further comprising pressurizing the subterranean formation.

16. The method of claim 12, wherein the liquid/liquid separator is operated by pressure supplied by the subterranean formation.

17. A liquid/liquid separator for separating oil from other liquids comprising:
a pressurized tank for receiving from a subterranean formation a fluid having oil and at least a second liquid;
at least one oleophilic material positioned within the tank;
a motor for moving the at least one oleophilic material within the pressurized tank;
a device for desorbing oil from the at least one oleophilic material; and
at least one valve positioned near the device to allow the oil to exit the tank.

18. The apparatus of claim 17, wherein the at least one oleophilic material is selected from the group consisting of a belt, a screen, and a rope.

19. The apparatus of claim 17, wherein the device configured to extract oil is selected from the group consisting of a squeegee, a pinch roller, a wiper, and a twist guide.

20. The apparatus of claim 17, wherein the at least one valve further comprises a floater that floats in water and sinks in oil.
